(19) United States
(12) Patent Application Publication
(10) Pub. No.: US 2016/0255007 A1
(43) Pub. Date: Sep. 1, 2016

(54) Matrix Load Balancing Within Network Packet Communication Systems

(71) Applicant: IXIA, Calabasas, CA (US)

(72) Inventors: Dennis J. Cox, Austin, TX (US); Kristopher Raney, Austin, TX (US)

(21) Appl. No.: 14/633,204

(22) Filed: Feb. 27, 2015

(51) Int. Cl. H04L 12/803

(52) U.S. Cl. CPC H04L 47/125

(57) ABSTRACT

Systems and methods are disclosed for matrix load balancing within network packet communication systems. The disclosed embodiments in part identify multiple sets of different load balancing parameters, select one or more parameters within each set of load balancing parameters to form a matrix of load balancing parameters, generate load balancing rules (e.g., unique keys and/or signatures) based upon the matrix of load balancing parameters, apply the load balancing rules to one or more load balancers within a network packet communication system, and use the one or more load balancers to determine how packets are distributed within the network packet communication system.

### RELATED APPLICATIONS

This application is related to the following concurrently filed patent application: U.S. Patent Application Ser. No. _____, which is entitled “DYNAMIC RESOURCE MANAGEMENT FOR LOAD BALANCING IN NETWORK PACKET COMMUNICATION SYSTEMS,” which is hereby incorporated by reference in its entirety.

### TECHNICAL FIELD OF THE INVENTION

This invention relates to network packet communication systems and, more particularly, to load balancing within such communication systems.

### BACKGROUND

Network packet communication systems include a variety of network-connected systems that facilitate, manage, or control network packet traffic within the communication system. These network-connected systems can include gateways, routers, switches, interfaces, and/or other network-connected devices or processing systems that operate at various processing levels within the communication system. With respect to these various processing levels, different packet communication protocols are often used that are not compatible with each other such that processing systems at one processing level within a packet network communication system may use protocols that are not understood by processing systems operating at other processing levels within the packet network communication system.

Network communications also include sessions and related packet flows associated with applications running on a wide variety of network-connected user devices. For example, within a network packet communication system, applications running on personal computers, mobile devices, and/or other processing platforms may form one or more communication sessions with a variety of network-connected systems, and each of these sessions can include multiple packet flows. Network management systems are often used to control various parameters associated with packet sessions and flows for applications running within a monitored network communication system. These parameters can include, for example, packet priority, bandwidth usage, and/or other session/flow parameters for the network communication system. As these application-based packet sessions/flows are often dynamic in nature, they are often formed and removed as user devices operate within the network packet communication system.

Network packet communication systems also often include network monitoring tools. These monitoring tools are used to monitor network traffic associated with the network packets being communicated within the network communication system on an ongoing basis. To meet these monitoring needs, copies of network packets can be forwarded to network packet analysis tools. Network packet analysis tools include a wide variety of devices that analyze packet traffic, including traffic monitoring devices, packet sniffers, data recorders, voice-over-IP monitors, intrusion detection systems, network security systems, application monitors and/or other network management or security devices or systems. Packets can be forwarded to these network analysis tools using network hubs, test access ports (TAPs), switched port analyzer (SPAN) ports available on network switches, and/or other techniques.

Network packet communication systems, therefore, include a wide variety of processing devices and systems that perform various functions within the network infrastructure. And these processing systems operate at different processing levels within the network packet communication system to provide a variety of operational functions for the network packet communication system. The packet protocols and packet related parameters used at these various processing levels are often significantly different and dependent upon the particular operational functions being implemented at these processing levels.

FIG. 1 (Prior Art) is a block diagram of an example embodiment for an LTE (Long Term Evolution) voice and data network that uses network packet communications and includes a variety of processing systems operating at different processing levels within the network packet communication system. For the example embodiment 100 depicted in FIG. 1 (Prior Art), an LTE network is implemented using the SAE (System Architecture Evolution) network architecture for the 3GPP (3^{rd} Generation Partnership Project) LTE wireless communication standard. For this example embodiment 100, user equipment (UE) 102 and UE 104 are wirelessly connected to an MME (mobility management entity) 110 and/or a serving gateway (SGW) 112 through eNodeB (Evolved Node B) interfaces 106/108. A home subscriber server (HSS) 114 is connected to the MME 110, and the SGW 112 is connected to a packet gateway (PGW) 118. The PGW 118 connects the network to a PDN (public data network) 120, such as the Internet, and the PGW 118 is also connected to a PCRF (Policy and Charging Rules Function) 116 related to the PDN 120. The LTE network connections for embodiment 100 include: (a) S1-MME connections between eNodeB interfaces 106/108 and the MME 110, (b) S1-U connection between eNodeB interfaces 106/108 and the SGW 112; (c) an S11 connection interface between the MME 110 and the SGW 112, (d) an S6a connection interface between the MME 110 and the HSS 114, (e) an S5/S8 connection interface between the SGW 112 and the PGW 118, (f) an S7 interface between the PGW 118 and the PCRF 116, and (g) an SGi connection interface between the PGW 118 and the PDN 120. Thus, as shown in FIG. 1 (Prior Art), a number of groups of processing systems are provided at a number of different processing levels within the network packet communication system that makes up the LTE network.

Load balancers are often used within a network communication system to balance workloads among a group of similar devices, systems, or components that perform the same or similar function. For example, a load balancer can be used to balance workloads among a group of gateway controllers; a separate load balancer can be used to balance workloads among a group of routers; and a further load balancer can be used to balance workloads among a group of network analysis tools. However, such existing load balancers have little, if any, visibility into overall network system functionality and performance. Rather, these existing load balancers are focused on balancing loads for the particular function being performed by the group of processing systems with respect to which the load balancers are balancing workloads.

FIG. 2 (Prior Art) is a block diagram of an example embodiment 200 where load balancers have been included within an LTE communication system, such as the one shown in FIG. 1 (Prior Art), to distribute packets among groups of similar devices. For the example embodiment 200, multiple MMEs 110A/110B/110C are included within the network communication system, and a load balancer 202 is used to balance packets among these MMEs 110A/110B/110C. Similarly, multiple SGWs 112A/112B/112C are included within the network communication system, and a load balancer 204 is used to balance packets among these multiple SGWs 112A/112B/112C. Further, multiple PGWs 118A/118B/118C are included within the network communication system, and a load balancer 206 is used to balance packets among these multiple PGWs 118A/118B/118C. These load balancers 202, 204, and 206 operate independently to distribute and balance loads among the particular systems and devices to which they are connected.

Processing systems or components within a packet network communication system can also operate within virtual processing environments, such as virtual machine (VM) platforms hosted by one or more processing systems. For example, one or more of the eNodeB, MME, SGW, and/or PGW processing systems within embodiment 100 of FIG. 1 (Prior Art) can be virtualized such that they operate as one or more VM platforms within a virtual environment. Virtual resources can be made available, for example, through processors and/or processing cores associated with one or more server processing systems or platforms (e.g., server blades) used to provide software processing instances or VM platforms within a server processing system. A virtual machine (VM) platform is an emulation of a processing system that is created within software being executed on a VM host hardware system. By creating VM platforms within a VM host hardware system, the processing resources of that VM host hardware system become virtualized for use within the network communication system. The VM platforms can be configured to perform desired functions that emulate one or more processing systems.

FIG. 3 (Prior Art) is a block diagram of an example embodiment for a virtual machine (VM) host hardware system 300 that communicates with an external network 318 such as a network packet communication system. For the example embodiment depicted, the VM host hardware system 300 includes a central processing unit (CPU) 302 that runs a VM host operating system 354. An interconnect bridge 308 couples the CPU 302 to additional circuitry and devices within the VM host hardware system 300. For example, a system oscillator 310, a real-time clock 312, a network interface card (NIC) 315, and other hardware (H/W) 314 are coupled to the CPU 302 through the interconnect bridge 308. The system oscillator 310 can also have a direct connection to the CPU 302, and the NIC 315 can also include an additional oscillator 316. Other hardware elements and variations can also be provided.

The VM host hardware system 300 also includes a hypervisor 352 that executes on top of the VM host operating system (OS) 354. This hypervisor 352 provides a virtualization layer including a plurality of VM platforms 356A, 356B, 356C . . . that emulate processing systems and provide related processing resources. As shown with respect to VM platform 356A, each of the VM platforms 356A, 356B, and 356C are configured to have one or more virtual hardware resources associated with it, such as a virtualized network interface card (NIC) 358A, a virtualized CPU 360A, a virtualized memory 362A, and/or other virtualized hardware resources. The VM host hardware system 300 hosts each of the VM platforms 356A, 356B, 356C . . . and makes their processing resources and results available to the external network 318 through the VM host operating system 354 and the hypervisor 352. As such, the hypervisor 352 provides a management and control virtualization interface layer for the VM platforms 356A-C. It is further noted that the VM host operating system 354, the hypervisor 352, the VM platforms 356A-C, and the virtualized hardware resources 358A/360A/362A can be implemented, for example, using computer-readable instructions stored in a non-transitory data storage medium that are accessed and executed by one or more processing devices, such as the CPU 302, to perform the functions for the VM host hardware system 300.

As indicated above, with respect to an LTE network, VM platforms within a virtualization layer can implement one or more processing systems to provide virtual functionality for a network packet communication system, such as an LTE network. FIG. 4 (Prior Art) is a block diagram of an example embodiment for a server system 400 including a VM environment 402 for SGWs and a VM environment 404 for PGWs within an LTE network. For the example embodiment 400, a number of processing system platforms 410, such as blade servers that include VM host hardware systems 300, are connected to an external packet-based communication network 401 and to each other through a switch 412. For the example embodiment 400, the processing system platforms 410 are configured into three nominal groups as indicated by nodes 411, 413, and 415. The processing system platforms 410 within each group are managed together to provide virtual processing resources as part of the network packet communication system. For the example embodiment 400, one group 414 of processing system platforms 410 is used to host a VM environment 402 that includes virtual machine (VM) platforms 404A, 404B . . . 404C operating as PGW1, PGW2 . . . PGW(N) respectively. One other group 416 of processing system platforms 410 is used to host a VM environment 406 that includes virtual machine (VM) platforms 408A, 408B . . . 408C operating as SGW1, SGW2 . . . SGW(N) respectively. It is noted that other groupings of processing system platforms 410 can also be used or all of the processing system platforms 410 can be managed individually or as a single unit. Further, it is noted that the processing system platforms 410 can be connected to each other by a high-speed communication backbone.

Similar to the load balancers described above with respect to FIG. 2 (Prior Art), load balancers have been added to the virtual environment to balance workloads among a group of similar devices, systems, or components that perform the same or similar function. For example, a PGW load balancer 403 can be added within VM environment 402 to balance packets among the VM platforms 404A, 404B . . . 404C operating as PGWs within the LTE network. Similarly, an SGW load balancer 405 can be added within the VM environment to balance packets among the VM platforms 808A, 808B . . . 808C operating as SGWs within the LTE network. However, such independent virtual load balancers 403/405 still have little, if any, visibility into overall network system functionality and performance for the LTE network.

### SUMMARY OF THE INVENTION

Systems and methods are disclosed for matrix load balancing within network packet communication systems. The disclosed embodiments in part identify multiple sets of different load balancing parameters, select one or more parameters within each set of load balancing parameters to form a matrix of load balancing parameters, generate load balancing rules (e.g., unique keys and/or signatures) based upon the matrix of load balancing parameters, apply the load balancing rules to one or more load balancers within a network packet communication system, and use the one or more load balancers to determine how packets are distributed within the network packet communication system. Different features and variations can be implemented, as desired, and related systems and methods can be utilized, as well.

For one embodiment, a method to load balance packets within a network packet communication system is disclosed that includes identifying a plurality of sets of load balancing parameters where each set of load balancing parameters being different from the other sets of load balancing parameters, selecting one or more parameters within each set of load balancing parameters to form a matrix of load balancing parameters, generating load balancing rules based upon the matrix of load balancing parameters, applying the load balancing rules to one or more load balancers within a network packet communication system, and using the one or more load balancers to determine how packets are distributed within the network packet communication system.

In further embodiments, the plurality of sets of load balancing parameters includes at least on set of load balancing parameters associated with a packet protocol and at least one set of load balancing parameters associated with a network session for a user device within the network packet communication system. In still further embodiments, the plurality of sets of load balancing parameters includes at least one set of load balancing parameters associated with an application running within the network packet communication system. In other embodiments, the method also includes providing a graphical user interface and allowing selection of the one or more parameters within each set of load balancing parameters through the graphical user interface.

In additional embodiments, the method also includes receiving information from a plurality of load balancers within the network communication system concerning operation of the plurality of load balancers. In further embodiments, the method can include adjusting the plurality of sets of load balancing parameters based upon the received information. In still further embodiments, the method can include adjusting the plurality of sets of load balancing rules based upon the received information. In other embodiments, the method can include using the received information to track changes to selected parameters within the matrix of selected load balancing parameters.

In still further embodiments, the identifying, selecting, generating, applying, and using steps occur within a virtual machine environment. In addition, the method can include operating at least one processing devices to provide the virtual machine environment. Further, the method can include operating a plurality of processing devices to provide the virtual machine environment.

For another embodiment, a load balancing system for network packet communications is disclosed that includes one or more load balancers within a network packet communication system and a load balancer controller. The one or more load balancers are each configured to distribute packets within the network packet communication system based upon load balancing rules where each set of load balancing parameters is different from the other sets of load balancing parameters. The load balancer controller is configured to identify a plurality of sets of load balancing parameters, to select one or more parameters within each set of load balancing parameters to form a matrix of load balancing parameters, to generate load balancing rules based upon the matrix of load balancing parameters, and to apply the load balancing rules to the load balancers within a network packet communication system.

In further embodiments, the plurality of sets of load balancing parameters includes at least on set of load balancing parameters associated with a packet protocol and at least one set of load balancing parameters associated with a network session for a user device within the network packet communication system. In still further embodiments, the plurality of sets of load balancing parameters includes at least one set of load balancing parameters associated with an application running within the network packet communication system. In other embodiments, the load balancing system also includes a graphical user interface configured to allow selection of the one or more parameters within each set of load balancing parameters.

In additional embodiments, the load balancing system also includes a plurality of load balancers, and each of the load balancers is configured to provide information concerning its operation to the load balancer controller. In further embodiments, the load balancer controller is further configured to adjust the plurality of sets of load balancing parameters using the information. In still further embodiments, the load balancer controller is further configured to adjust the plurality of sets of load balancing rules based upon the information. In other embodiments, the load balancer controller is further configured track changes to selected parameters within the matrix of selected load balancing parameters based upon the information.

In still further embodiments, the one or more load balancers and the load balancer controller are configured to operate within a virtualization machine environment. In addition, at least one processing device can be configured to provide the virtual machine environment. Further, a plurality of processing devices can be configured to provide the virtual machine environment.

Different and/or additional features, variations, and embodiments can also be implemented, as desired, and related systems and methods can be utilized, as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 (Prior Art) is a block diagram of an example embodiment for an LTE (Long Term Evolution) voice and data network that uses network packet communications and includes a variety of processing systems operating at different processing levels within the LTE network.

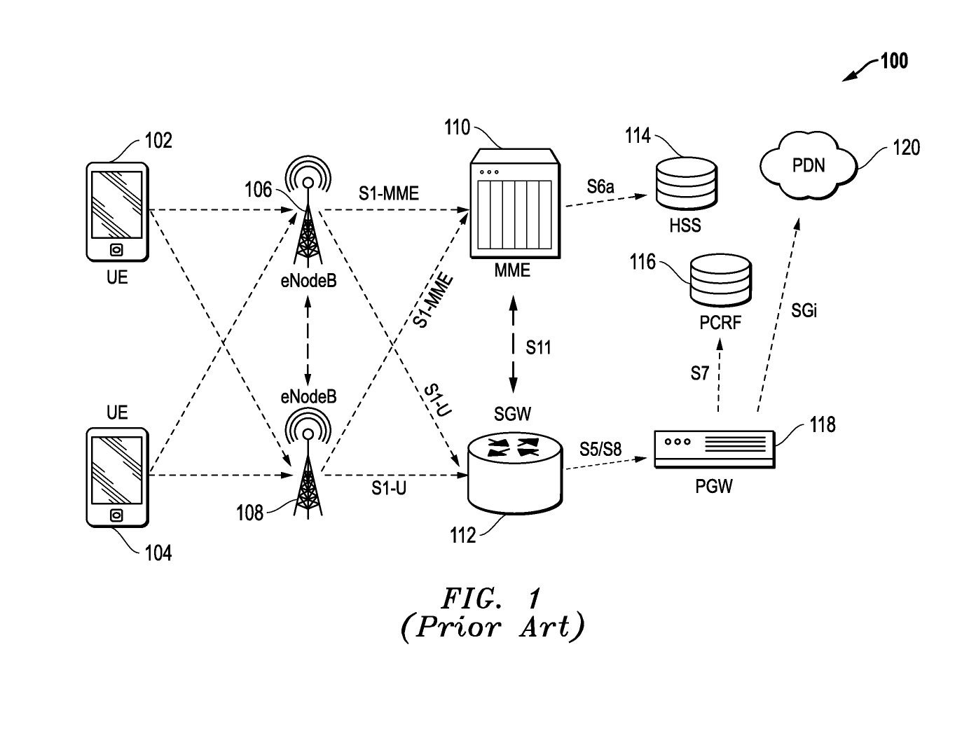

FIG. 2 (Prior Art) is a block diagram of an example embodiment where load balancers have been included within an LTE communication system to distribute packets among groups of similar devices.

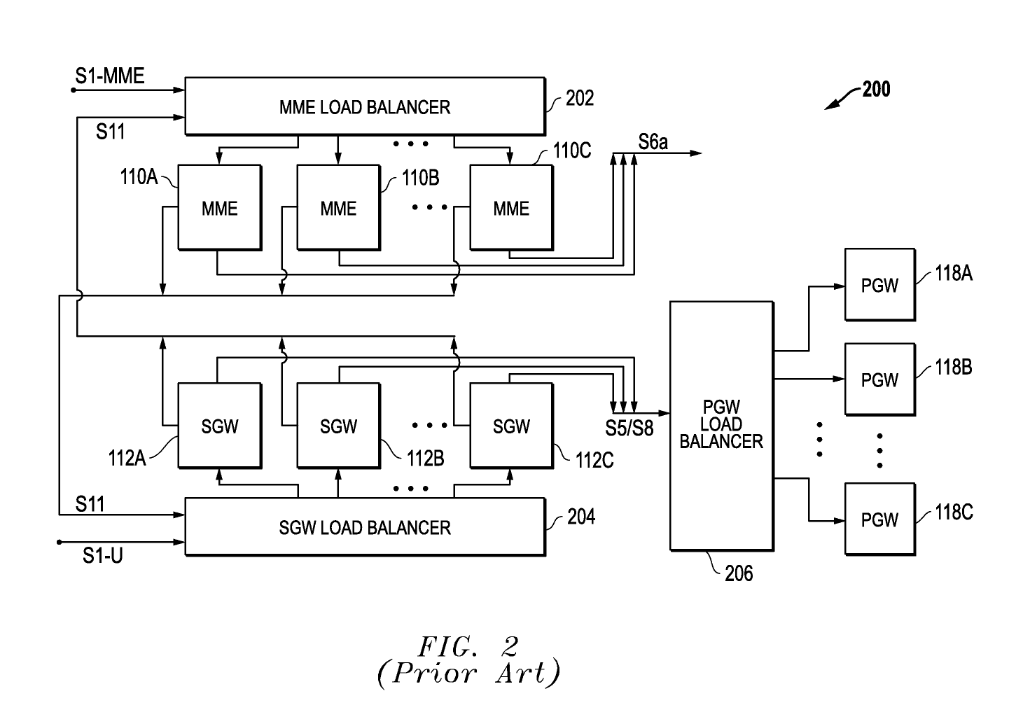

FIG. 3 (Prior Art) is a block diagram of an example embodiment for a virtual machine (VM) host hardware system that communicates with an external network packet communication system.

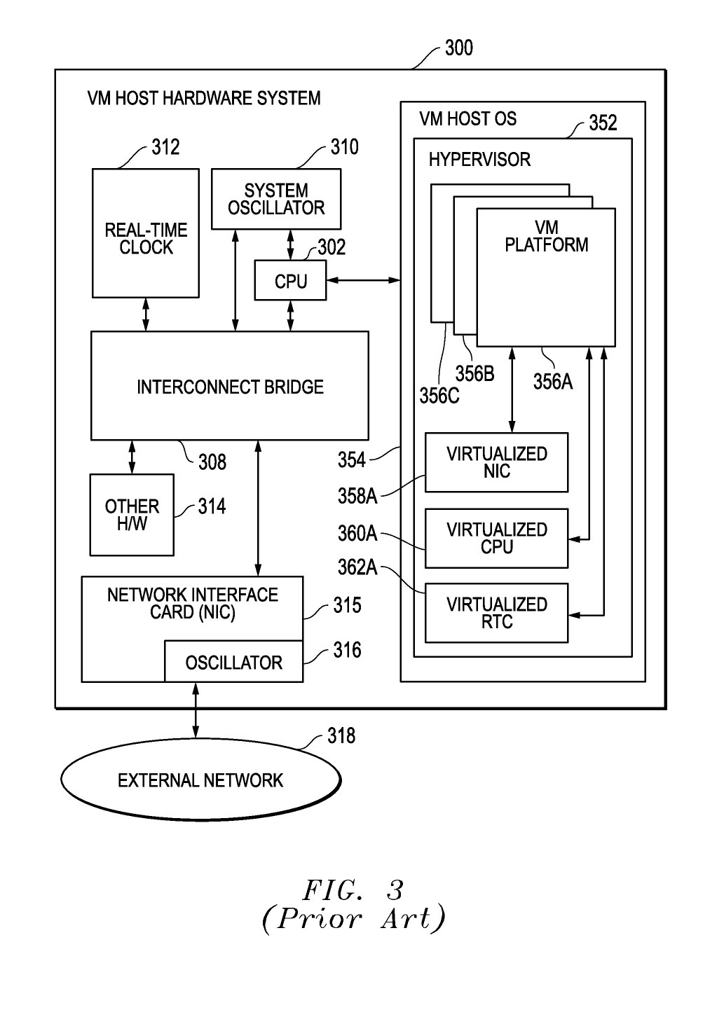

FIG. 4 (Prior Art) is a block diagram of an example embodiment for a server system including virtual machine (VM) platforms for processing systems within an LTE network.

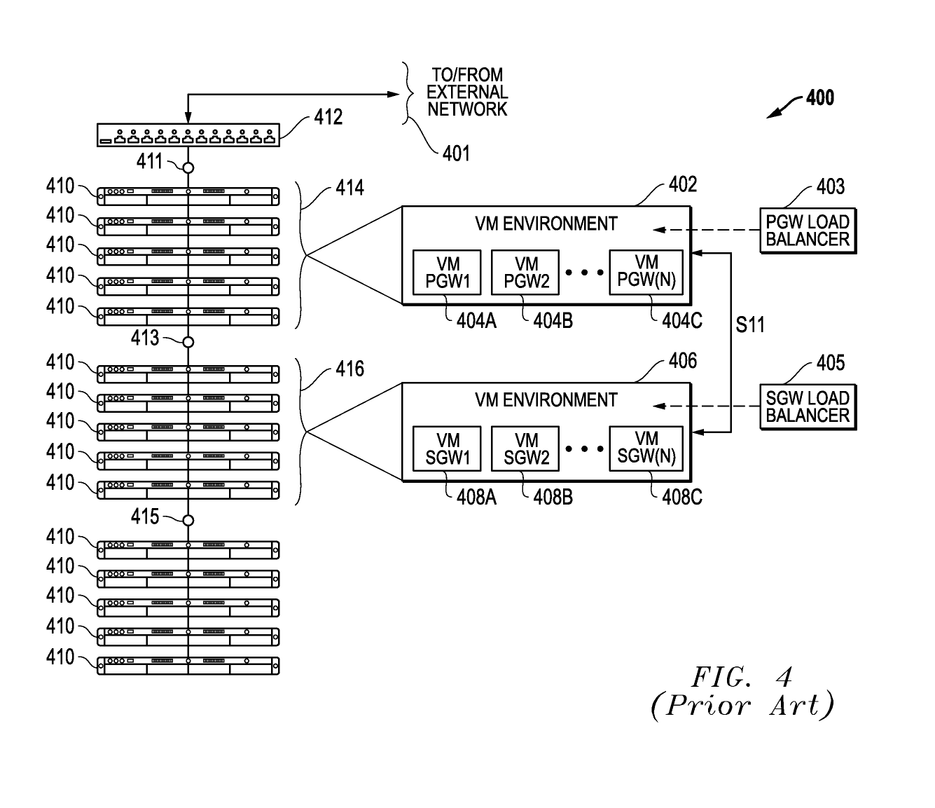

FIG. 5 is a block diagram of an example embodiment for matrix load balancing within a network packet communication system having one or more load balancers.

FIG. 6 is a block diagram of an example embodiment where matrix load balancing is applied to processing systems within an LTE network.

FIG. 7 is a block diagram of an example embodiment where matrix load balancing is applied to VM platforms within virtual environments within an LTE network.

FIG. 8 is a block diagram of an example embodiment for a matrix load balancer controller that provides control messages to load balancers associated with different levels of processing.

FIG. 9 is a block diagram of an example embodiment for components for a matrix generator and load balancer rules engine that can be included within the matrix load balancer controller.

FIG. 10 is a block diagram of an example embodiment for further components of a matrix generator and load balancer rules engine that can be included within the matrix load balancer controller.

FIG. 11 is a block diagram of an example embodiment for a graphical user interface that can be used to make parameter selections from a plurality of different parameter selection modules.

FIG. 12 is a process flow diagram of an example embodiment for generating a load balancer parameter selection matrix and for applying rules based upon this matrix to load balancers at multiple processing levels within a packet network communication system.

### DETAILED DESCRIPTION OF THE INVENTION

Systems and methods are disclosed for matrix load balancing within network packet communication systems. The disclosed embodiments in part identify multiple sets of different load balancing parameters, select one or more parameters within each set of load balancing parameters to form a matrix of load balancing parameters, generate load balancing rules (e.g., unique keys and/or signatures) based upon the matrix of load balancing parameters, apply the load balancing rules to one or more load balancers within a network packet communication system, and use the one or more load balancers to determine how packets are distributed within the network packet communication system. Different features and variations can be implemented, as desired, and related systems and methods can be utilized, as well.

The matrix load balancing embodiments described herein provides significant flexibility in selecting and applying parameters for the load balancers operating within a network packet communication system. Instead of relying solely upon port numbers or IP (Internet Protocol) addresses within a packet, the matrix load balancer controller allows fields from multiple different sets of parameters associated with packet protocols, communication sessions/flows, applications running within the network, and/or other sets of parameters to be selected and used for load balancing. These selected parameters are used to generate a matrix of selected parameters, and this matrix of selected parameters is then used to generate load balancing rules, such as unique keys or signatures, that are applied to load balancers within the network packet communication system and used to identify and forward packets to desired network destinations. Rather than generate these unique matrix-based keys or signatures based upon one set of similar parameters (e.g., one packet protocol or one session/flow), the matrix load balancing described herein leverage a matrix of selectable parameters among a variety of sets of parameters (e.g., multiple protocols and/or sessions/flows) to allow different types of packet protocols, sessions/flows, applications, and/or other disparate packet-based parameters of the network to be forwarded to common or desired destinations based upon these unique matrix-based keys or signatures that can be generated, for example, using user selection of parameters among different sets of parameters.

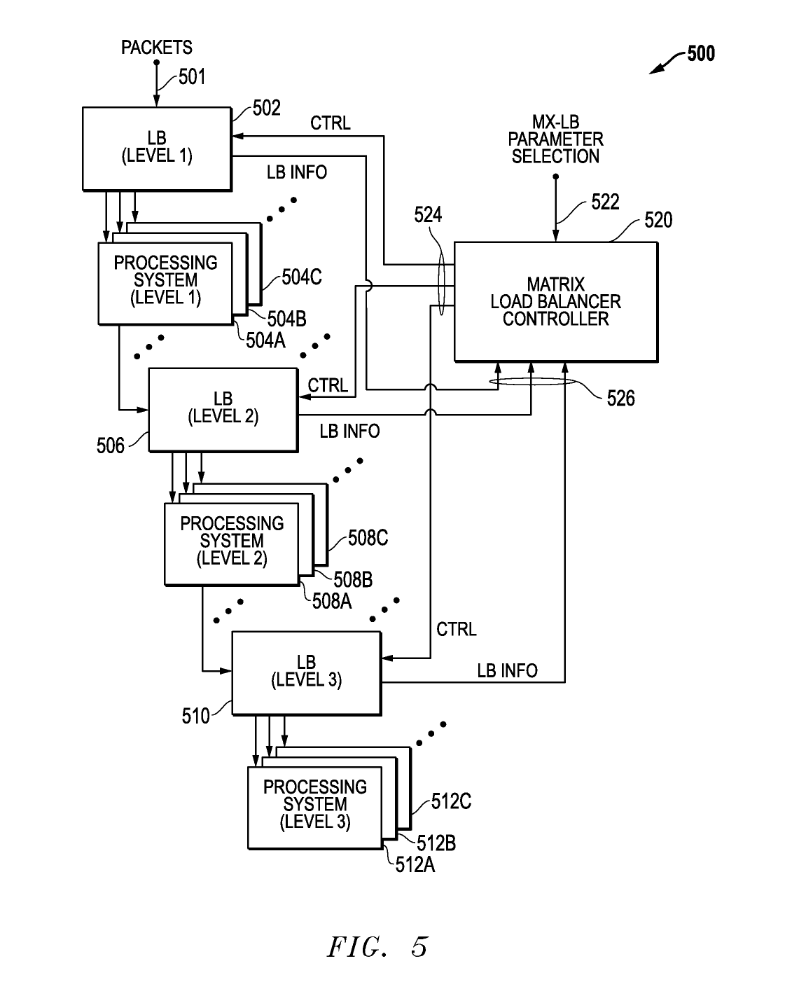

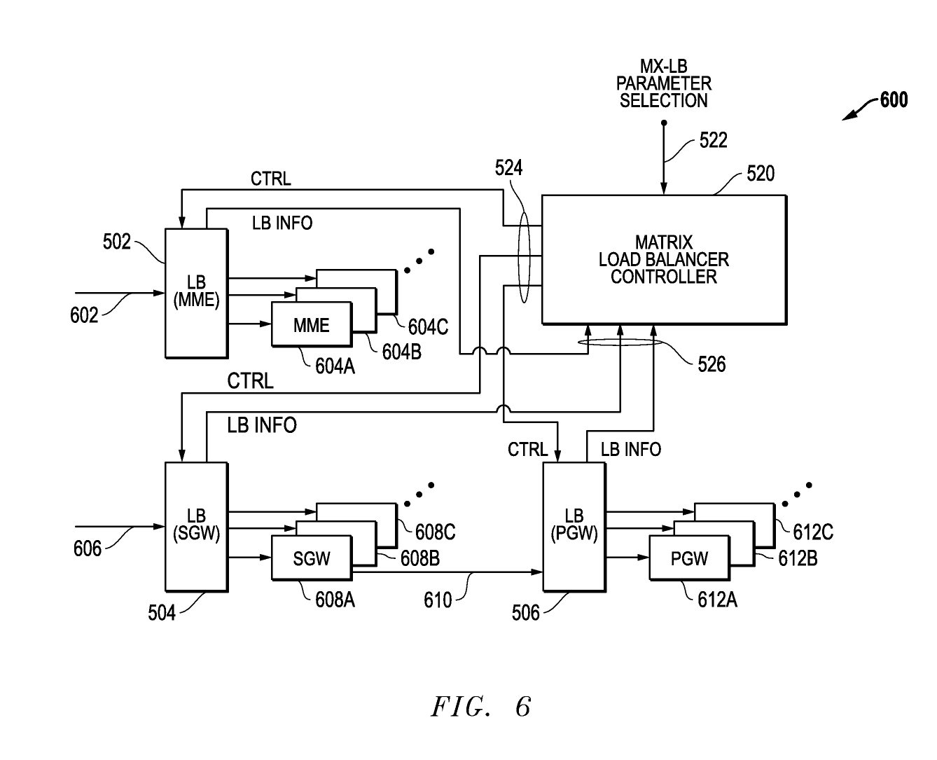

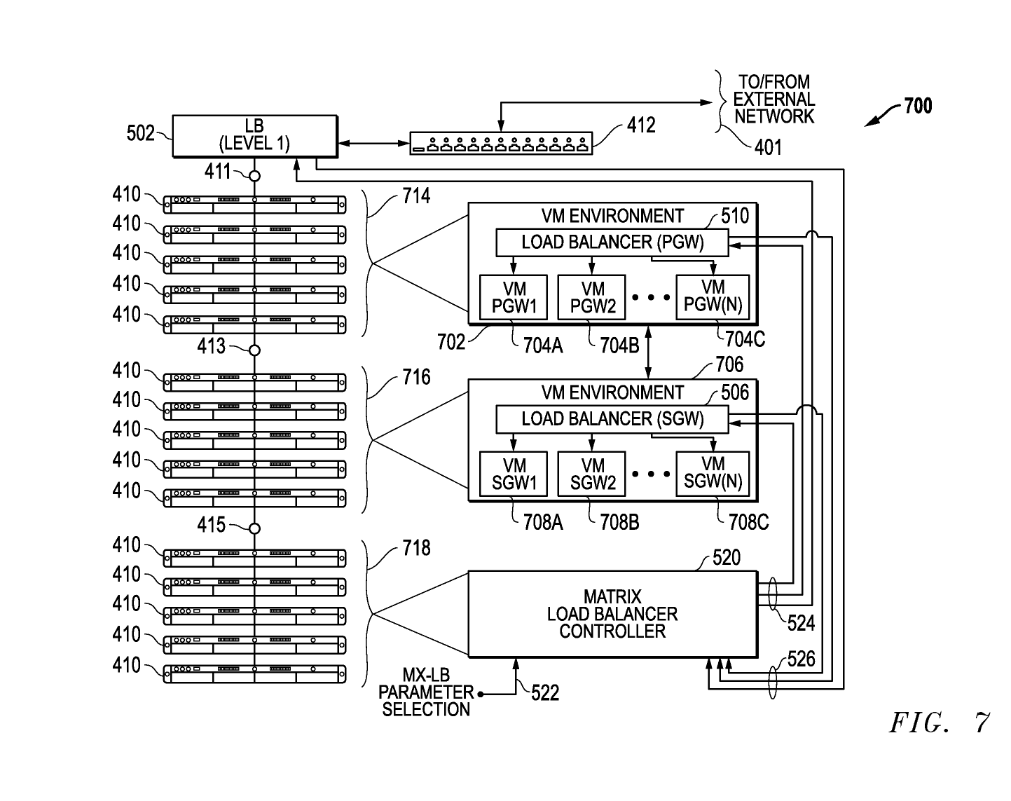

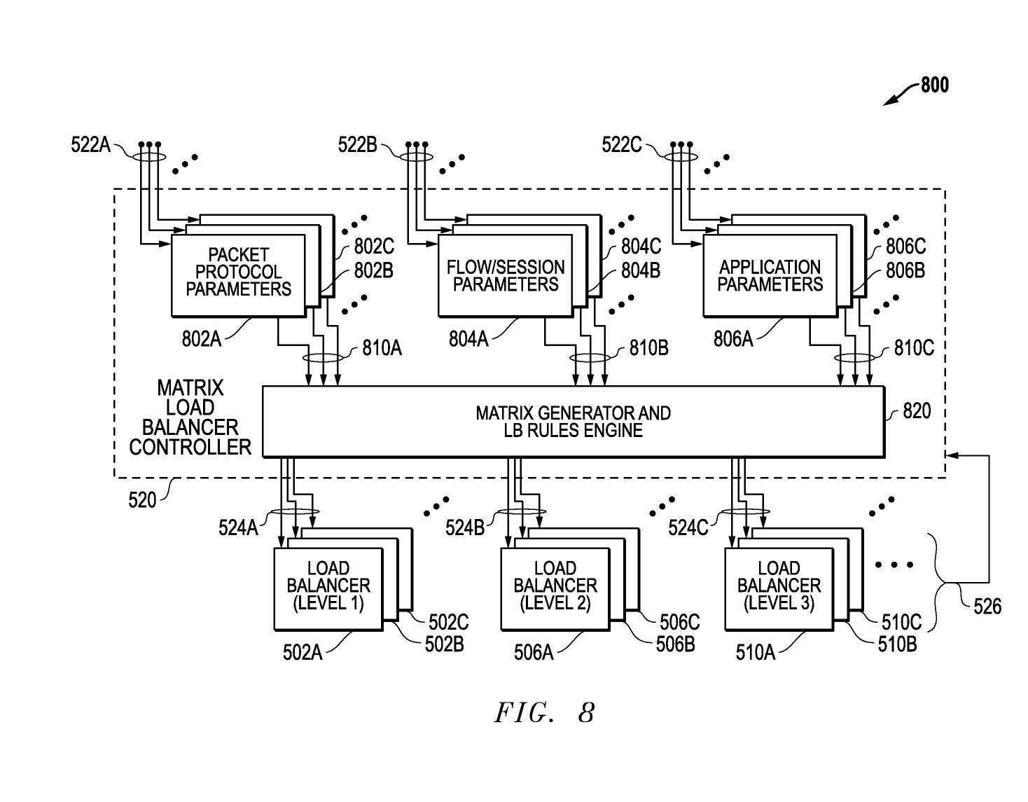

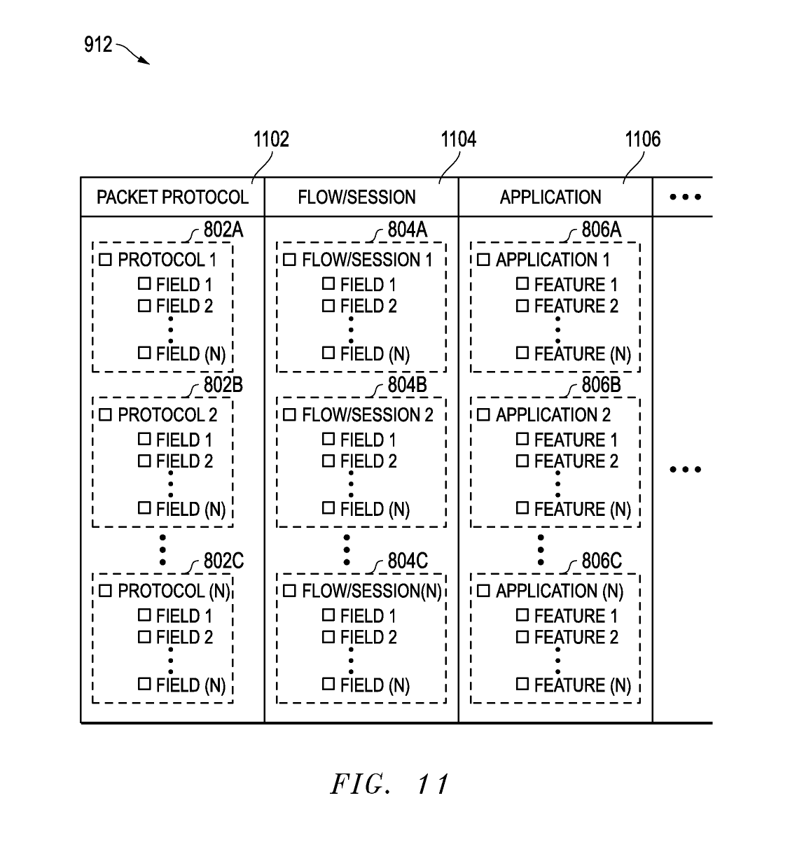

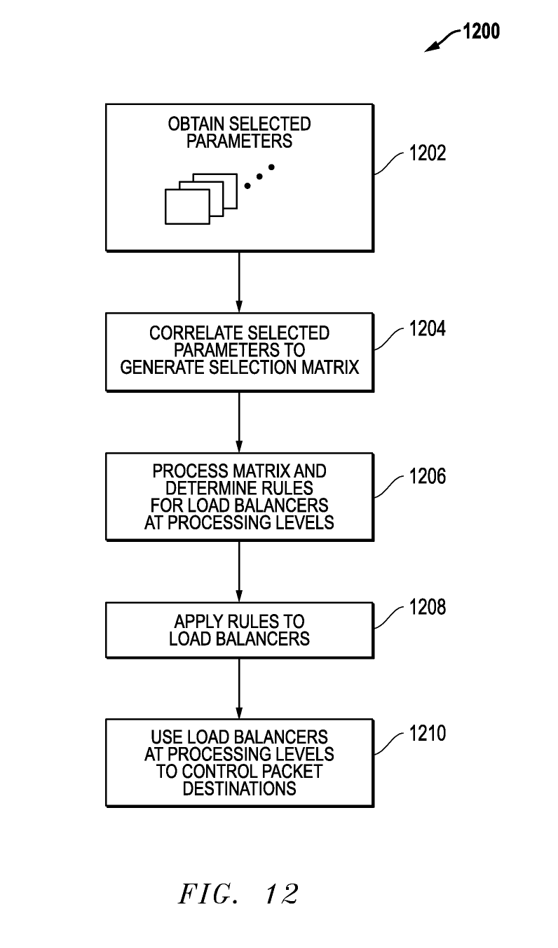

The matrix load balancing embodiments will now be described in more detail with respect to the drawings. FIG. 5 is a block diagram of an example embodiment for matrix load balancing within a network packet communication system. FIGS. 6-7 provide example embodiments for matrix load balancing applied to an LTE (Long Term Evolution) network and to a virtualized processing environment, respectively. FIGS. 8-10 provide additional example embodiments for a matrix load balancer controller. FIG. 11 provides an example graphical user interface (GUI) for parameter selection. And FIG. 12 provides a process flow diagram for matrix load balancing. It is again noted that different features and variations can also be implemented, and related systems and methods can be utilized as well.

Looking first to FIG. 5, a block diagram is shown for an example network packet communication system embodiment 500 for matrix load balancing within a network packet communication system having one or more load balancers. In particular, a matrix load balancer 520 communicates with one or more load balancers 502, 506, 510 . . . that operate to balance packets among processing systems operating at one or more different processing levels for a network packet communication system. As described in more detail below, the matrix load balancer controller 520 allows for selection of load balancing parameters from a plurality of different sets of load balancing parameters associated with different packet protocols, packet sessions/flows, applications, and/or other network operations to form a matrix of load balancing parameters. This matrix of load balancing parameters is then used to generate load balancing rules that are applied to the load balancers 502, 506, 510 . . . to control how packets are distributed to the processing systems within the network packet communication system.

For the example embodiment 500 depicted, input network packets 501 are received by a first load balancer 502. The load balancer 502 provides load balancing at a first level of processing among a first group of processing systems 504A, 504B, 504C . . . that operate to provide similar functions for this first level of processing. A second load balancer 506 receives packets from the processing system 504A, and the second load balancer 506 provides load balancing at a second level of processing among a second group of processing systems 508A, 508B, 508C . . . that operate to provide similar functions for this second level of processing. A third load balancer 510 receives packets from the processing system 508A, and the third load balancer 510 provides load balancing at a third level of processing among a third group of processing systems 512A, 512B, 512C . . . that operate to provide similar functions for this third level of processing. Although not shown, it is noted that each of the other first level processing systems 504B, 504C . . . can output packets to a separate load balancer and additional processing systems and that each of the other second level processing systems 508B, 508C . . . can output packets to a separate load balancer and additional processing systems. Other variations can also be implemented.

The matrix load balancer controller 520 communicates with each of the load balancers 502, 506, 510 . . . to provide control messages (CTRL) 524 that include load balancing rules that are applied to the load balancers 502, 506, 510 . . . to determine at least in part how the load balancers 502, 506, 510 . . . operate to distribute packets among the processing systems to which they are connected. These control messages 524 are based in part upon matrix load balancer (MX-LB) parameter selection inputs 522 that select and form a matrix of load balancing parameters that is used determine how the load balancers 502, 506, 510 . . . will work together to balance loads across the different processing levels of the embodiment 500. Further, the selected parameters can be linked by one or more Boolean operations (e.g., AND, OR, etc.) to provide greater flexibility in the control of the matrix load balancer controller 520. In addition, the matrix load balancer controller 520 also receives load balancer (LB) information 526 from each of the load balancers 502, 506, 510 . . . that can include operational information about the load balancers including the load balancing parameters used by the load balancers 502, 506, 510 . . . to determine how packets are distributed among the processing systems to which they are connected. The LB information 526 can be used by the matrix load balancer controller 520, for example, to determine sets of load balancing parameters from which parameters can be selected to form the matrix of load balancing parameters that is used to provide load balancing rules to the load balancers 502, 506, 510 . . . to control how packets are distributed, as described in more detail below. Although three groups of processing systems and three load balancers are depicted for embodiment 500, it is noted that other numbers of processing system groups and related load balancers can also be provided while still taking advantage of the matrix load balancing techniques described herein.

In operation, the matrix load balancer controller 520 provides significant flexibility in selecting and applying parameters for the load balancers it controls. Instead of relying solely upon port numbers or IP addresses within a packet, the matrix load balancer controller 520 allows any field in a packet or flow to be selected and used for load balancing. These parameter selections generate a matrix of selected parameters from various packet protocols and/or flows. This matrix of selected parameters is then used to generate a unique matrix-based key that can be used to identify packets to be forwarded to a particular destination by one or more load balancers being controlled by the matrix load balancer controller 520. Rather than generate this unique matrix-based key based upon any one packet protocol or any one flow, the matrix load balancer controller 520 leverages the matrix of selectable parameters among a variety of protocols and/or flows to allow different types of packets and flows to be forwarded to a common destination based upon these unique matrix-based keys that are generated using user selection of parameters.

For example, where load balancers are placed at different processing levels of a network, the different processing levels can employ different packet protocols and include different flows with respect to particular users. Through the matrix load balancer controller 520, as described in more detail below, a user can select parameters within the different packet protocols and packet flows that will be used to determine packets to forward to processing systems connected to the load balancers being controlled by the matrix load balancer controller 520. Further, identifiers generated for users can be dynamically determined and tracked by the matrix load balancer controller 520 through LB information 526 sent to the matrix load balancer controller 520 during operation. As such, the user can be tracked as different identifiers are generated and removed for different sessions and related flows with respect to the user. For example, temporary identifiers (IDs) generated for user equipment (UE) within an LTE network, such as a cell phone, can be tracked as they are generated, and packets having these tracked identifiers can be forwarded to a common destination by the load balancers. These identifiers can include identifiers associated with sessions between the UE and various websites or web applications (e.g., AMAZON session identifier, GOOGLE session identifier, FACEBOOK session identifier, etc.). By allowing selection of fields across various packet protocols and flows/sessions within the network packet communication system, the matrix load balancer controller 520 allows for packets associated with various flows and packet protocols within the network packet communication system to be tracked and forwarded to desired destinations connected to the load balancers being controlled by the matrix load balancer controller within the network.

It is noted that the matrix load balancer controller 520 can be implemented using one or more operational modules, and these operational modules can be operated on one or more separate processing devices or systems. For example, a portion of the operational modules for the matrix load balancer controller 520 could operate on one or more processing systems at a first geographic location, and another portion of the operational modules for the matrix load balancer controller 520 could operate on one or more processing systems at a second geographic location. The processing systems at the two different geographic locations can then communicate with each other to facilitate the overall operation of the matrix load balancer controller 520. As described further below, the matrix load balancer controller 520 can also be implemented as part of one or more virtual environments. Other variations could also be implemented.

FIG. 6 is a block diagram of an example embodiment 600 where matrix load balancing is applied to processing systems within an LTE network. For this embodiment 600, the different processing levels are represented by a group of MMEs, a group of SGWs, and a group of PGWs. Input network packets 602 are received by a first load balancer 502. The load balancer 502 provides load balancing at a first level of processing among a first group of processing systems 604A, 604B, 604C . . . that to provide MME operational functionality for this first level of processing. A second load balancer 506 receives input packets 606, and the second load balancer 506 provides load balancing at a second level of processing among a second group of processing systems 608A, 608B, 608C . . . that operate to provide SGW operational functionality for this second level of processing. A third load balancer 510 receives packets from the processing system 608A, and the third load balancer 510 provides load balancing at a third level of processing among a third group of processing systems 612A, 612B, 612C . . . that operate to provide PGW functionality for this third level of processing. Although not shown, it is noted that additional processing systems and load balancers can also be provided. Other variations can also be implemented.

As described above, the matrix load balancer controller 520 communicates with each of the load balancers 502, 506, 510 . . . to provide control messages (CTRL) 524 including load balancing rules that are applied to the load balancers 502, 506, 510 . . . to determine at least in part how the load balancers 502, 506, 510 . . . operate to distribute packets among the processing systems to which they are connected. As above, these control messages 524 are based in part upon matrix load balancer (MX-LB) parameter selection inputs 522 that select and form a matrix of load balancing parameters that is used determine how the load balancers 502, 506, 510 . . . will work together to balance loads across the different processing levels of the embodiment 600. Although three groups of processing systems and three load balancers are depicted for the LTE embodiment 600, it is noted that other numbers of processing system groups and related load balancers can also be provided while still taking advantage of the matrix load balancing embodiments techniques described herein.

FIG. 7 is a block diagram of an example embodiment 700 where matrix load balancing is applied to a VM environment within an LTE network. For this embodiment 700, the different processing levels are represented by a virtual environment 702 for a group of VM platforms operating as SGWs and a virtual environment 706 for a group of VM platforms operating as PGWs. Further, for the example embodiment 700 depicted, a number of processing system platforms 410, such as blade servers that include VM host hardware systems 300 as described above, are connected to an external communication network 401 and to each other through a switch 412. For the example embodiment 700 depicted, the processing system platforms 410 are configured into three groups as indicated by nodes 411, 413, and 415. A load balancer 502 can also be provided to distribute packets among the different processing system platforms 410. The processing system platforms 410 within each group can be managed together to provide virtual processing resources as part of the network packet communication system. For the example embodiment depicted, one group 716 of processing system platforms 410 is used to host a VM environment 706 that includes virtual machine (VM) platforms 708A, 708B . . . 708C operating as SGW1, SGW2 . . . SGW(N) respectively. The VM environment 706 also includes virtual SGW load balancer 506. One other group 714 of processing system platforms 410 is used to host the VM environment 702 that includes virtual machine (VM) platforms 704A, 704B . . . 704C operating as PGW1, PGW2 . . . PGW(N) respectively. The VM environment 702 also includes the virtual PGW load balancer 510. An additional group 718 of processing system platforms 410 is used to host a virtual matrix load balancer controller 520. It is further noted that the processing system platforms 410 can be connected to each other by a high-speed communication backbone.

As described above, the virtual matrix load balancer controller 520 communicates with each of the load balancers 502/506/510 to provide control messages (CTRL) 524 to the load balancers 502/506/510 to determine at least in part how the load balancers 502/506/510 operate to distribute packets among the processing systems to which they are connected. These control messages 524 are based in part upon matrix load balancer (MX-LB) parameter selection inputs 522 that select and form a matrix of load balancing parameters that is used determine how the load balancers 502, 506, 510 . . . will work together to balance loads across the different processing levels of the embodiment 700. Although two groups of processing systems and two load balancers are depicted for the virtual LTE processing embodiment 700, it is noted that other numbers of processing system groups and related load balancers can also be provided while still taking advantage of the matrix load balancing techniques described herein. It is further noted that processing system platforms 410 can be implemented, for example, using computer-readable instructions stored in a non-transitory data storage medium that are accessed and executed by one or more processing devices to perform the functions for the processing system platforms 410. It is also noted that the processing system platforms 410 can be implemented, for example, using one or more processing devices such as processors and/or configurable logic devices. Processors (e.g., microcontrollers, microprocessors, central processing units, etc.) can be programmed and used to control and implement the functionality described herein, and configurable logic devices such as CPLDs (complex programmable logic devices), FPGAs (field programmable gate arrays), and/or other configurable logic devices can also be programmed to perform desired functionality. Other variations could also be implemented.

As indicated above, FIGS. 8-10 provide example embodiments for the matrix load balancer controller 520 as well as for operational blocks within the matrix load balancer controller 520. FIG. 11 provides an example GUI for selecting parameters, and FIG. 12 provides an example process flow diagram.

FIG. 8 is a block diagram of an example embodiment 800 for a matrix load balancer controller 520 that provides control messages to load balancers associated with different levels of processing for the embodiments of FIGS. 5-7. For embodiment 800, the load balancer 520 includes a matrix generator and LB rules engine 820 that receives selected parameters 810A/810B/810C associated with a number of different parameter selection modules 802A-C/804A-C/806A-C, processes these selected parameter to generate a matrix of load balancing parameters, determines load balancing rules for the load balancers, and applies these rules through control messages communicated to the load balancers. In particular, the parameter selection modules 802A-C/804A-C/806A-C provide any of a wide variety of parameters associated with the load balancing being performed by the load balancers 502A-C/506A-C/510A-C within the overall network packet communication system. For example, one or more packet protocol selection modules 802A, 802B, 802C . . . can be provided to allow for selection of parameters 810A associated with one or more different packet protocols through parameter selection inputs 522A. One or more flow/session selection modules 804A, 804B, 804C . . . can also be provided to allow for selection of parameters 810B associated with one or more different packet packets flows or sessions through parameter selection inputs 522B. Further, one or more application selection modules 806A, 806B, 806C . . . can be provided to allow for selection of parameters 810C associated with one or more different applications through parameter selection inputs 522C. Different and/or additional parameter selection modules can also be provided with respect to matrix load balancer controller 520, if desired, to provide additional sets of selectable parameters.

The matrix generator and LB rules engine 802 receives and processes the selected parameters 810A, 810B, 810C . . . to form a matrix of load balancing parameters and to generate control messages 524A, 524B, 524C that when applied to the load balancers will implement the load balancing selections made through the various parameter selection modules. As depicted, control messages 524A are applied to load balancers 502A, 502B, 502C . . . that are operating to perform processing at a first level; control messages 524B are applied to load balancers 506A, 506B, 506C . . . that are operating to perform processing at a second level; and control messages 524C are applied to load balancers 510A, 510B, 5102 . . . that are operating to perform processing at a third level. Different and/or additional control messages and load balancers could also be utilized while still taking advantage of the matrix load balancing techniques described herein.

As described above, it is also noted that the matrix load balancer controller 520 can receive load balancer information 526 from the load balancers 502A-C/506A-C/510A-C that includes operational information about the load balancers including parameters used by the load balancers during operation. Further, it is noted that the matrix load balancer controller 520 can use this load balancer information 526 to determine the parameters to make available for selection within the parameter selection modules 802A-C, 804A-C, and 806A-C. Other variations can also be implemented.

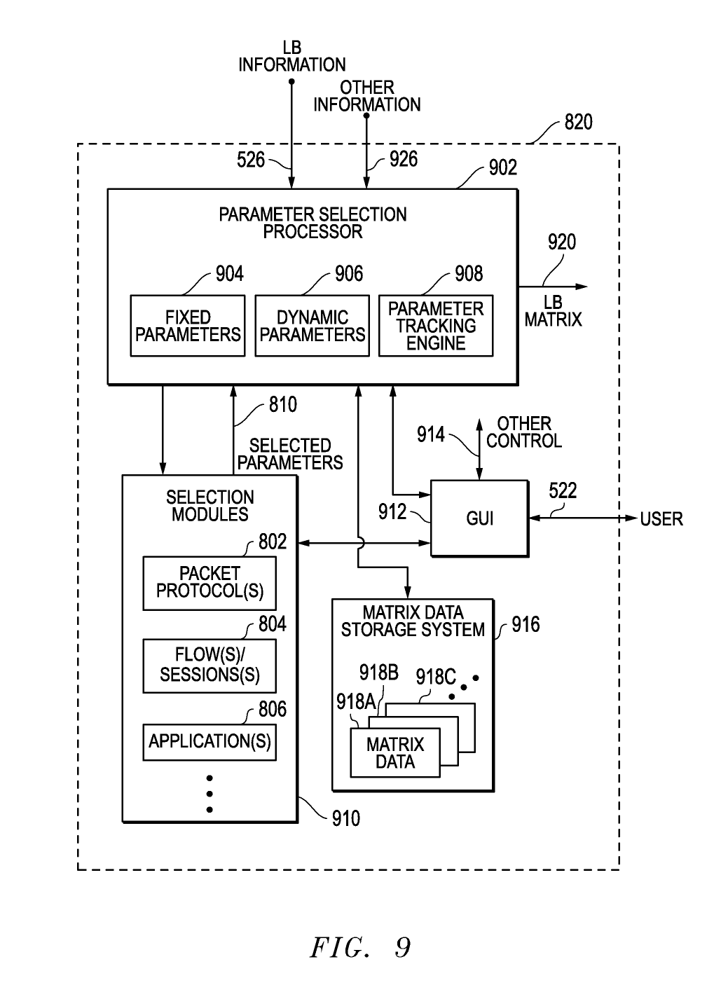

FIG. 9 is a block diagram of an example embodiment of components for a matrix generator and load balancer (LB) rules engine 820 that can be included within the matrix load balancer controller 520. A parameter selection processor 902 receives the load balancer information 526 and/or other information 926 and determines parameters to be made available for selection in the selection modules 910. As described above, the selection modules 910 can include any of a wide variety of selectable parameters associated with the network packet communication system. The parameter selection processor 902 can use fixed parameters 904 and/or dynamic parameters 906 to make this parameter determination. The fixed parameters 904 represent parameters that are programmed into the matrix load balancer controller 520 prior to operation, and the dynamic parameters 906 represent parameters generated during operation of the matrix load balancer controller 520. For example, the load balancing information 526 received from the load balancers can be used by the parameter selection processor 902 to generate the dynamic parameters 906. The parameter selection processor generates one or more selection modules 910 based upon the fixed parameters 904 and/or the dynamic parameters 906. As described above, the selection modules 910 can include one or more selection modules 802 including parameters associated with one or more packet protocol(s), one or more selection modules 804 including parameters associated with one or more packet flow(s) or sessions(s), one or more selection modules 806 associated with one or more application(s) 806, and/or other additional selection modules associated with other parameters relating to the network packet communication system.

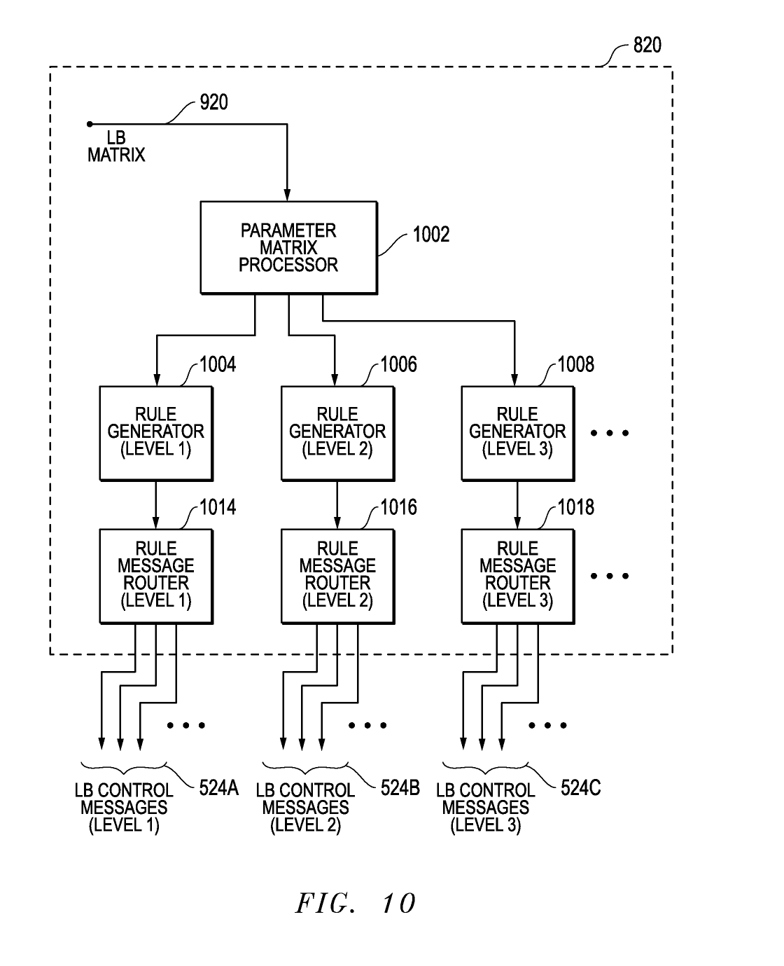

The matrix load balancer controller 520 can also provide a graphical user interface (GUI) 912, for example, as part of the matrix generator and LB rules engine 820. For example, selectable parameters for the selection modules 910 can be displayed to a user through the GUI 912, and the user can provide control inputs 522 that select one or more parameters within the selection modules 910. The selected parameters 810 can then be provided back to the parameter selection processor 902 which can store the selected parameters as one or more sets of matrix data 918A, 918B, 918C . . . within a matrix data storage system 916. As such, this matrix data 918A, 918B, 918C . . . can then be output as a matrix of LB parameters 920 to a rules engine as described below with respect to FIG. 10. If desired, the matrix data storage system 916 can also be bypassed or removed such that the matrix of selected parameters is provided to the rules engine without first being stored. Further, the GUI 912 can also provide user selectable control for operations of the parameter selection processor 902 and/or other operational features of the matrix load balancer controller 520 through control inputs 914. For example, the operation of the rules engine in FIG. 10 discussed below can also be controlled in part by a user through the GUI 912, if desired. Other variations could also be implemented while still taking advantage of the matrix load balancing techniques described herein.

The matrix load balancer controller 520, for example within the parameter selection processor 902, can further include a parameter tracking engine 908 that can be configured to track one or more parameters associated with the packet network communication system. For example, as described further below, it may be desirable to track user identification information that is generated and deleted with respect to user sessions and/or related packet flows within the packet network communication system. These parameters can be provided to the parameter tracking engine 908 as part of the LB information 526 communicated by the load balancers to the matrix load balancer controller 520. The parameter tracking engine 908 can further be used to adjust data stored in the matrix data storage system 916, and the matrix data 918A, 918B, 918C . . . stored for parameter selections made through the selection modules 910. In particular, the parameter tracking engine 908 can adjust the data within the matrix data 918A, 918B, 918C . . . , such as user ID information, as it changes dynamically over time within the packet network communication system.

FIG. 10 is a block diagram of an example embodiment for further components for the matrix generator and LB rules engine 820. The matrix of load balancing (LB) parameters 920 from the parameter selection processor 902 is received and processed by the parameter matrix processor 1002 and then processed by the rule generators 1004/1006/10018 to generate rules that are applied to the load balancers within the network packet communication system. For example, the matrix data can be processed by the rule generators 1004/1006/1008 to generate load balancing rules that rely upon unique keys and/or signatures that are based upon the matrix of selected parameters and that can be used by the load balancers to identify packets that fall with the matrix of selected parameters. For the example embodiment in FIG. 10, the parameter matrix processor 1002 processes the parameters within the LB matrix 920, correlates the selected parameters within the LB matrix 920 to determine overlapping selections, and parses the selected parameters into parameters associated with different processing levels. The parameter matrix processor 1002 then forwards parameters for a first level of processing to a rule generator 1004 for the first level of processing. The rule generator 1004 then outputs first level load balancing rules to rule message router 1014. The rule message router 1014 then separates these first level rules into control messages 524A applied to the first level load balancers, such as load balancers 502A, 502B, 502C . . . shown in FIG. 8. Similarly, the parameter matrix processor 1002 forwards parameters for a second level of processing to a rule generator 1006 for the second level of processing, The rule generator 1006 then outputs second level load balancing rules to rule message router 1016. The rule message router 1016 then separates these second level rules into control messages 524B applied to the second level load balancers, such as load balancers 506A, 506B, 506C . . . shown in FIG. 8. Further, the parameter matrix processor 1002 forwards parameters for a third level of processing to a rule generator 1008 for the third level of processing, The rule generator 1008 then outputs third level load balancing rules to rule message router 1018. The rule message router 1018 then separates these third level rules into control messages 524C applied to the third level load balancers, such as load balancers 510A, 510B, 510C . . . shown in FIG. 8. Different and/or additional rule generators and/or rule message routers can also be used depending upon the load balancers within the network packet communication system that will be controlled using the matrix load balancer controller 520 and the matrix generator and load balancer (LB) rules engine 820.

FIG. 11 is a block diagram of an example embodiment for graphical user interface (GUI) 912. For the example embodiment depicted, selectable parameters are provided in one or more columns 1102, 1104, 1106 . . . within the GUI 912. For example, column 1102 includes selectable parameters for packet protocol selection modules 802A, 802B . . . 802C including one or more FIELDS 1, 2 . . . (N) associated with one or more PROTOCOLS 1, 2 . . . (N) operating within the network packet communication system. Column 1104 includes selectable parameters for flows/session selection modules 804A, 804B . . . 804C including one or more FIELDS 1, 2 . . . (N) associated with one or more FLOWS/SESSIONS 1, 2 . . . (N) generated within the network packet communication system. Column 1106 includes selectable parameters for software application selection modules 806A, 806B . . . 806C including one or more FEATURES 1, 2 (N) associated with one or more APPLICATIONS 1, 2 . . . (N) operating within the network packet communication system. It is further noted that different and/or additional selection configurations, views and/or windows can be used for displaying the selectable parameters through the GUI 912, as desired. Further, as indicated above, different and/or additional selectable parameters can also be provided.

FIG. 12 is a process flow diagram of an example embodiment 1200 for generating a load balancer parameter selection matrix and for applying rules to load balancers at multiple processing levels within a packet network communication system. In block 1202, multiple sets of selected parameters are obtained for load balancing parameters. As described above, these sets of selected parameters can be generated, for example, by one or more users accessing the matrix load balancer controller 520 through a graphical user interface, and selectable parameters can also include fixed and/or dynamic parameters along with parameters that are tracked and updated during operation of the packet network communication system and the matrix load balancer controller 520. In block 1204, the sets of selected parameters within the load balancing selection matrices are correlated by the matrix generator and LB rules engine 820 to form a matrix of selected parameters. In block 1206, the matrix generator and LB rules engine 820 processes the LB parameter matrix with respect to available load balancers within multiple processing levels for the packet network communication system and determines rules for these load balancers at the various processing levels within the packet network communication system. In block 1208, the rules are applied to the load balancers so that the load balancers are configured to forward packets based upon the rules. In block 1210, the load balancers at the various processing levels for the packet network communication system control packet destinations using the applied rules so that packets are in fact forwarded based upon the LB rules that were generated and applied based upon the LB parameter matrix. It is further noted that different and/or additional process steps could also be implemented while still taking advantage of the matrix load balancing techniques described herein.

It is noted that the operational and functional blocks described herein can be implemented using hardware, software or a combination of hardware and software, as desired. In addition, integrated circuits, discrete circuits or a combination of discrete and integrated circuits can be used, as desired, that are configured to perform the functionality described. Further, configurable logic devices can be used such as CPLDs (complex programmable logic devices), FPGAs (field programmable gate arrays), ASIC (application specific integrated circuit), and/or other configurable logic devices. In addition, one or more processors running software or firmware could also be used, as desired. For example, computer readable instructions embodied in a tangible medium (e.g., memory storage devices, FLASH memory, random access memory, read only memory, programmable memory devices, reprogrammable storage devices, hard drives, floppy disks, DVDs, CD-ROMs, and/or any other tangible storage medium) could be utilized including instructions that cause computer systems, processors, programmable circuitry (e.g., FPGAs, CPLDs), and/or other processing devices to perform the processes, functions, and capabilities described herein. It is further understood, therefore, that one or more of the tasks, functions, or methodologies described herein may be implemented, for example, as software or firmware and/or other instructions embodied in one or more non-transitory tangible computer readable mediums that are executed by a CPU (central processing unit), controller, microcontroller, processor, microprocessor, FPGA, CPLD, ASIC, or other suitable processing device or combination of such processing devices.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A method to load balance packets within a network packet communication system, comprising:
identifying a plurality of sets of load balancing parameters, each set of load balancing parameters being different from the other sets of load balancing parameters;
selecting one or more parameters within each set of load balancing parameters to form a matrix of load balancing parameters;
generating load balancing rules based upon the matrix of load balancing parameters;
applying the load balancing rules to one or more load balancers within a network packet communication system; and
using the one or more load balancers to determine how packets are distributed within the network packet communication system.

2. The method of claim 1, wherein the plurality of sets of load balancing parameters comprises at least on set of load balancing parameters associated with a packet protocol and at least one set of load balancing parameters associated with a network session for a user device within the network packet communication system.

3. The method of claim 1, wherein the plurality of sets of load balancing parameters comprises at least one set of load balancing parameters associated with an application running within the network packet communication system.

4. The method of claim 1, further providing a graphical user interface and allowing selection of the one or more parameters within each set of load balancing parameters through the graphical user interface.

5. The method of claim 1, further comprising receiving information from a plurality of load balancers within the network communication system concerning operation of the plurality of load balancers.

6. The method of claim 5, further comprising adjusting the plurality of sets of load balancing parameters based upon the received information.

7. The method of claim 5, further comprising adjusting the plurality of sets of load balancing rules based upon the received information to adjust

8. The method of claim 5, further comprising using the received information to track changes to selected parameters within the matrix of selected load balancing parameters.

9. The method of claim 1, wherein the identifying, selecting, generating, applying, and using steps occur within a virtual machine environment.

10. The method of claim 9, further comprising operating at least one processing devices to provide the virtual machine environment.

11. The method of claim 9, further comprising operating a plurality of processing devices to provide the virtual machine environment.

12. A load balancing system for network packet communications, comprising:
one or more load balancers within a network packet communication system, each load balancer being configured to distribute packets within the network packet communication system based upon load balancing rules; and
a load balancer controller configured to identify a plurality of sets of load balancing parameters, to select one or more parameters within each set of load balancing parameters to form a matrix of load balancing parameters, to generate load balancing rules based upon the matrix of load balancing parameters, and to apply the load balancing rules to the load balancers within a network packet communication system;
wherein each set of load balancing parameters is different from the other sets of load balancing parameters.

13. The load balancing system of claim 12, wherein the plurality of sets of load balancing parameters comprises at least on set of load balancing parameters associated with a packet protocol and at least one set of load balancing parameters associated with a network session for a user device within the network packet communication system.

14. The load balancing system of claim 12, wherein the plurality of sets of load balancing parameters comprises at least one set of load balancing parameters associated with an application running within the network packet communication system.

15. The load balancing system of claim 12, further comprising a graphical user interface configured to allow selection of the one or more parameters within each set of load balancing parameters.

16. The load balancing system of claim 12, wherein the one or more load balancers comprises a plurality of load balancers, and wherein each of the load balancers is configured to provide information concerning its operation to the load balancer controller.

17. The load balancing system of claim 16, wherein the load balancer controller is further configured to adjust the plurality of sets of load balancing parameters using the information.

18. The load balancing system of claim 16, wherein the load balancer controller is further configured to adjust the plurality of sets of load balancing rules based upon the information.

19. The load balancing system of claim 16, wherein the load balancer controller is further configured to use the information to track changes to selected parameters within the matrix of selected load balancing parameters.

20. The load balancing system of claim 12, wherein the one or more load balancers and the load balancer controller are configured to operate within a virtualization machine environment.

21. The load balancing system of claim 20, wherein at least one processing device is configured to provide the virtual machine environment.

22. The load balancing system of claim 20, wherein a plurality of processing devices are configured to provide the virtual machine environment.
